(19) United States
(12) Patent Application Publication
(10) Pub. No.: US 2002/0157320 A1
(43) Pub. Date: Oct. 31, 2002

(54) Sliding door - window security device

(76) Inventor: James A. Papp, Steamboat Springs, CA (US)

Correspondence Address: JAMES A PAPP, P O Box 882191, Steamboat Springs, CO, 80488, US

(21) Appl. No.: 09/771,174

(22) Filed: Apr. 25, 2001

(51) Int. Cl. E05F 1/00

(52) U.S. Cl. 49/449; 49/450

(57) ABSTRACT

A window and sliding door security device that is attached with a Velcro or hook and loop application.

This invention is installed on sliding windows and doors to provide security as well as ventilation. The invention utilizes the strength of Velcro or other hook and loop material.

### BACKGROUND

Security problems for sliding doors and windows have been a concern for many years. Present locking mechanisms are usually attached to the edge of the door or window then to the frame. Sliding doors can be defeated easily by using a pry bar near the lock to break it or to expose the locking mechanism. Also, a sliding door can be pried off the lower track and the entire glass panel removed. If a blocking object such as a broom handle is placed in the door channel, intruders need only use a bar tool to slide between the two doors where they overlap and flip the blocking object up. Use of a blocking object in no way prevents the removal of the whole sliding door unit. As with sliding doors, double hung window locks are defeated with a pry bar.

The challenge of security is further complicated as windows and doors are not adjustable with present locking mechanisms. The result is that the windows and doors are either closed and locked or open and not secure. Unfortunately, for security some people nail or screw windows and doors shut. Obviously, egress is then impossible in the event of a fire or other emergency. The available locking devices on windows and doors fail to address the problems faced by people with physical limitations or disabilities. The position of a person confined to a wheelchair may prevent them from even being able to reach a window locking device. Arthritis (for example) may impede the twisting motion necessary to lock or unlock a conventional double hung window. People who are visually impaired are prevented from using locking devices that require alignment of holes or other parts that cannot be accomplished by touch.

Currently, there are many secondary security systems for windows and doors available. One problem with these is that they require tools and, at the minimum, basic mechanical skills to install. Again, these systems assume no frailty or disability on the part of the installer.

### SUMMARY OF THE INVENTION

A. This device consists of a security device or devices which have Velcro or other hook and loop material attached lengthwise to one or more sides. The hook side of the material is attached to the security device, while the loop side is attached to the window or doors being secured. The Velcro or hook and loop material allows the device to be mated to the window or door.

B. The device can be made of metal, wood, plastic or similar materials. It can be of various lengths, depending on need, and can be of various shapes (for example, square, rectangular, half-moon).

C. The Velcro or hook and loop material can be self-adhesive, fixed with other adhesive, fixed mechanically or placed in the locking channels permanently fixed to the window or door.

D. The device can be adapted to fit existing windows or doors or made available or incorporated into windows or doors during manufacture.

E. The device can be fabricated in the shape of a right angle. If the hook material is applied to both legs of the right angle [see FIG. 2 and FIG. 4] and the device is placed in the corner of a sliding door, movement is blocked in both a vertical or horizontal position at the same time.

F. The blocking device is equipped with a handle, knob, chain or similar gripping hardware that allows its removal with a light pull.

G. The position of the device to the window or door via the hook and loop type material is variable depending on the needs of the user.

H. Since the position of the device is not fixed, it can be moved horizontally or vertically, allowing the window or door to be opened several inches to provide ventilation while maintaining security.

### Background—Description of Prior Art

The hook and loop security device is different from U.S. Pat. No. 6,070,918. In U.S. Pat. No. 6,070,918, Velcro fasteners are mentioned, but only as a method to affix an assist rod for a disabled operator to manipulate the device. It is not part of the locking mechanism but an option to hold a specialized tool in the proximity of the actual locking device.

### Advantages of this Invention

A. No tools or special skills are required for installation.

B. The self-adhesive hook and loop blocking device is ideal for use on vinyl, commonly used in the manufacture of doors and windows. While vinyl is an excellent, low-maintenance product, it is extremely difficult to attach screws to. It splits and the screws pull out easily.

C. The hook and loop security device is not fixed. It is adjustable vertically and horizontally along the mating strip. This allows the window or door to be open for ventilation yet locked in that position. For example, the window or door can be in the open position yet would not allow a 4 inch sphere to pass through the opening. The 4 inch sphere standard is the Uniform Building Code for openings such as stair or balcony railings to prevent a child from passing through.

D. The shear strength of the hook and loop material, that of the adhesive, as well as of the device itself prevents the mechanism from being defeated easily. Imagine the problem to detach the device which is fastened along its entire length and hits the window or door jamb or frame after moving less than 4 inches. If it is desirable to lock the window or door so it is in a closed position simply move the device so it is positioned against the jamb or frame. In the movement of both the window and door objects are required to bypass each other. The hook and loop blocking device prevents this from happening. If an attempt is made to pry a door completely out of a track a hook and loop blocking device placed vertically with attachments on both sides would lock the fixed panel in a locked position. This would prevent the door from being pried out of the track because it is attached in a fixed position to a non movable object.

E. The advantage for people with physical limitations or disabilities is in the design: a simple pull on a knob or chain will release the locking device. There are no keypads to punch, no complicated devices to unfasten and no problems for people who are visually impaired because of a medical condition or a smoke-filled room.

F. Affordability. The simplicity of this invention guarantees it will be affordable. It will be available to those individuals with or without disabilities requiring ease of installation, increased security, and increased child safety.

G. There is a real savings on energy when ventilation and the natural variation in temperature can replace air-conditioning. The most common reason for closing windows and doors, not only at night, but during day light hours is security.

### DRAWING FIGURES

FIG. 1 shows a blocking device with the hook and loop material attached.

FIG. 2 shows a right angle blocking device with the hook and loop material attached to two different planes.

FIG. 3 shows two blocking devices: one on the left side of a window in a closed position, and one on the right side of a window in a position that would allow the window to be opened but locked.

FIG. 4 shows a right angle blocking device that would block a window from moving both vertically and horizontally at the same time.

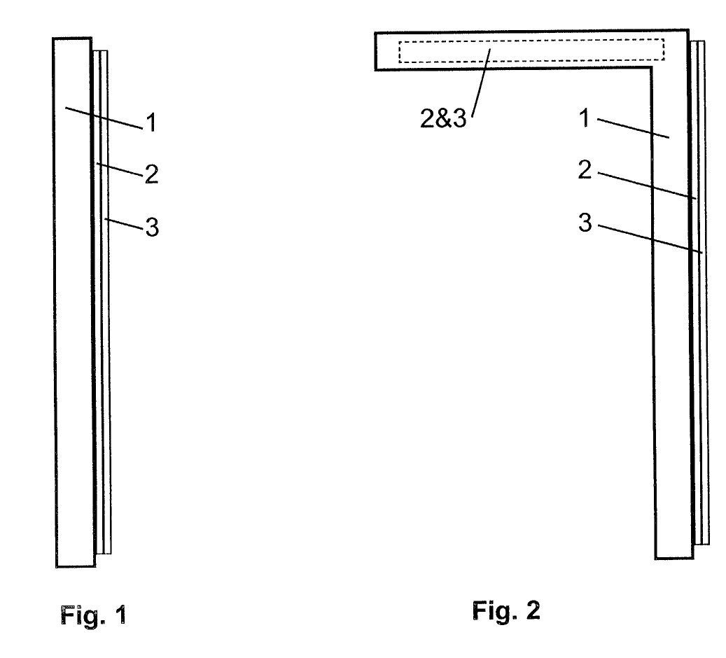

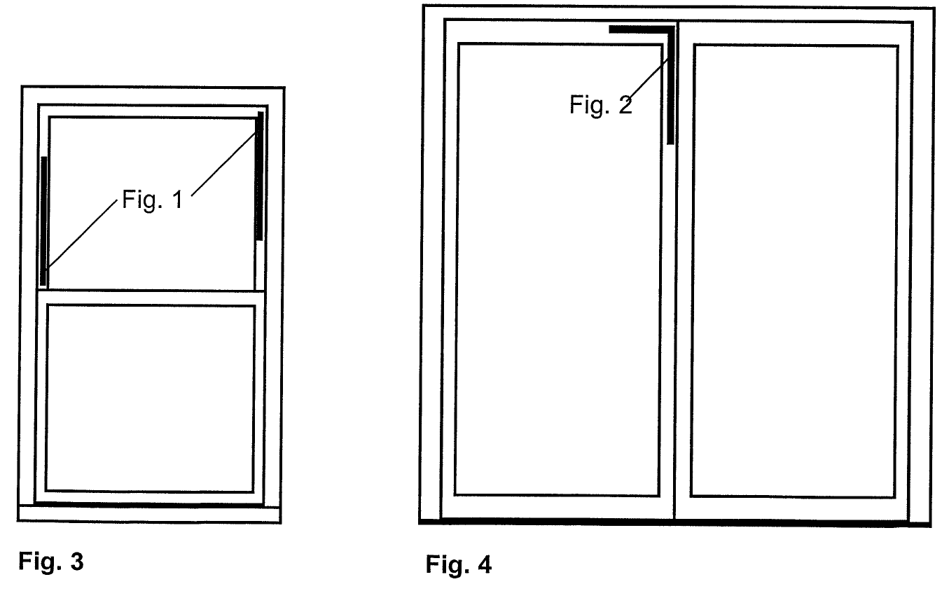

### REFERENCE NUMERALS IN DRAWING

1 is the blocking device.

2 is the hook material.

3 is the loop material.

### SUMMARY RAMIFICATIONS AND SCOPE

1. The hook and loop security blocking device has the following advantages

over conventional locking devices.

2. It requires no tools to install.

3. It is adjustable even after installation.

4. It can be installed on virtually any material.

5. It does not weaken or in any way alter the integrity of the window or door it is installed on.

6. It is very user friendly for people with limitations or disabilities.

7. It provides security while allowing ventilation.

8. It will be affordable.

1. A method of attaching a security device to a sliding window or door utilizing hook and loop technology.

2. Attaching the hook or loop material so that one element either the hook or loop is attached to the security device and the opposite element either the hook or loop is attached to the window or door.

3. The security device is attached to the window or door by mating the two elements hook and loop. Whereby, said blocking device will prevent the sliding element of the window or door from by passing each other.
